(19) United States
(12) Patent Application Publication
(10) Pub. No.: US 2015/0134479 A1
(43) Pub. Date: May 14, 2015

(54) SYSTEMS AND METHODS FOR MULTI-LEVEL RETAILING

(71) Applicant: Akshay Gadre, North Wales, PA (US)

(72) Inventor: Akshay Gadre, North Wales, PA (US)

(73) Assignee: EBAY INC., SAN JOSE, CA (US)

(21) Appl. No.: 14/076,905

(22) Filed: Nov. 11, 2013

(51) Int. Cl. G06Q 30/06

(52) U.S. Cl. CPC G06Q 30/0609
USPC 705/26.35

(57) ABSTRACT

An online retailer may have a number of items for sale. The online retailer may enable a reseller to resell one or more of the items for sale. The retailer may provide items to the reseller at a discount. The price paid by a customer may include a markup from the reseller. The reseller may have a reseller code. When a resold item is purchased by a customer, the reseller code may be provided to the retailer. Based on the reseller code, the retailer may determine the price to be charged to the customer. After an item is purchased by a customer, the markup for the reseller may be paid to the reseller. Resellers may be organized in a hierarchical relationship. One or more of the resellers above the reseller corresponding to the reseller code may receive a portion of the markup for the item.

### TECHNICAL FIELD

The subject matter disclosed herein generally relates to the processing of data. Specifically, the present disclosure addresses systems and methods for multi-level retailing.

### BRIEF DESCRIPTION OF THE DRAWINGS

Some embodiments are illustrated by way of example and not limitation in the figures of the accompanying drawings.

FIG. 1 is a network diagram illustrating a network environment suitable for multi-level retailing, according to some example embodiments.

FIGS. 2-4 are block diagrams illustrating components of application servers suitable for multi-level retailing, according to some example embodiments.

FIG. 5 is a block diagram illustrating components of a client machine suitable for multi-level retailing, according to some example embodiments.

FIGS. 6-10 are block diagrams illustrating user interfaces suitable for multi-level retailing, according to some example embodiments.

FIG. 11 is a block diagram illustrating a reseller hierarchy suitable for multi-level retailing, according to some example embodiments.

FIGS. 12-15 are flowcharts illustrating operations of an application server in performing methods of multi-level retailing, according to some example embodiments.

FIG. 16 is a block diagram illustrating components of a machine, according to some example embodiments, able to read instructions from a machine-readable medium and perform any one or more of the methodologies discussed herein.

### DETAILED DESCRIPTION

Example methods and systems are directed to multi-level retailing. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

An online retailer may have a number of items for sale. The items may be digital items (e.g., news articles, blogs, images, multimedia content, access to an online service), physical items (e.g., books, cars, toys), or other types of items. An item may be a collection of items. For example, each toy in a line of toys (e.g., a single Star Wars figure) may be an item and the collection of toys in the line of toys (e.g., all Star wars figures) may also be an item. As another example, an online bookstore may sell a physical book for shipment and an electronic book for download, and both the physical book and the electronic book may be items. As a further illustration, the item may be access to streaming multimedia content or an online game. The access may be for a limited period of time (e.g., one hour, one day, one week) or unlimited (e.g., for as long as the service is available).

The online retailer may enable a reseller to resell one or more of the items for sale. The reseller may provide an online storefront for the items and redirect the end customer to the retailer for actual placement of an order of the items. As an alternative, the reseller may provide an online storefront for the items, take an order of the items, and communicate with the retailer for fulfillment of the order. Enabling a reseller to resell one or more items may include an approval process. For example, the reseller and retailer may negotiate and sign a contract to enter into a reseller agreement. As another example, a third party may be given the authority by the retailer to approve resellers on behalf of the retailer.

The reseller may provide an online storefront to customers or rely on the retailer's storefront. The storefront may present information about the items being sold, such as name, image, description, price, shipping speed and cost, and the like. A reseller storefront may include items from a number of retailers. For example, a reseller may have a relationship with a book retailer and a vitamin supplement retailer, and provide an online storefront in which both the books and vitamin supplements are resold. The retailer may provide items to the reseller at a discount. For example, an item that retails for $10 may be sold to the reseller for $7. The price paid by the customer may include a markup from the reseller. For example, an item sold to the reseller for $7 may be sold to a customer for $9. Both the discount and the markup may be defined as an absolute amount (e.g., $2, $3) or as a percentage (e.g., 10%, 30%). The markup may be defined by the retailer or the reseller.

The reseller may have a reseller code. The reseller code may be specific to the retailer-reseller relationship or may be associated with the reseller in another way. For example, the reseller code may be the reseller's name, taxpayer identification number, social security number, Internet Protocol (IP) address, uniform resource locator (URL), and so forth. In other example embodiments, the reseller code is a number generated when the reseller is enabled or approved by the retailer.

When a resold item is purchased by a customer, the reseller code may be provided to the retailer. Based on the reseller code, the retailer may determine the price to be charged to the customer. For example, for a particular item, the retail price may be $10, the reseller price for a first reseller may be $7, the reseller price for a second reseller may be $6.50, and markup for both resellers may be $2. In this example, if no reseller code is given, the customer may be charged the retail price of $10. However, had the customer or the reseller provided the first reseller code to the retailer, the resale price of $9 may have been charged instead. Likewise, had the customer or the reseller provided the second reseller code to the retailer, the resale price of $8.50 may have been charged. In each of these cases, the resale price is the reseller price for the reseller corresponding to the reseller code plus the markup for the reseller. In some example embodiments, the difference between the resale price and the retail price is shown to the customer as a discount amount.

After an item is purchased by a customer, the markup for the reseller may be paid to the reseller. The payment to the reseller may be made periodically rather than after each individual purchase. For example, the amount owed to the reseller may be paid on a monthly basis. To illustrate, if ten items are sold in a month and the reseller's markup on each item is $20, the reseller may receive ten payments of $20 each, one payment of $200 at the end of the month, or some other combination of payments.

Resellers may be organized in a hierarchical relationship. For example, a second-tier reseller may be below a first-tier reseller, a third-tier reseller may be below a second-tier reseller, and so on. In some example embodiments, resellers may be connected to multiple resellers above them. In other example embodiments, resellers may have only a single reseller above them. A first-tier reseller may have no resellers above them. One or more of the resellers above the reseller corresponding to the reseller code may receive a portion of the markup for the item. For example, a second-tier reseller under a single first-tier reseller may set a markup of $2 on an item with a reseller price of $7 for the second-tier reseller. A customer may pay $9 for the item. The first-tier reseller may be entitled to 10% of the second-tier reseller's markup, and would receive $0.20 in this case. The second-tier reseller may be entitled to the remaining 90% of the markup, and would receive $1.80 in this case.

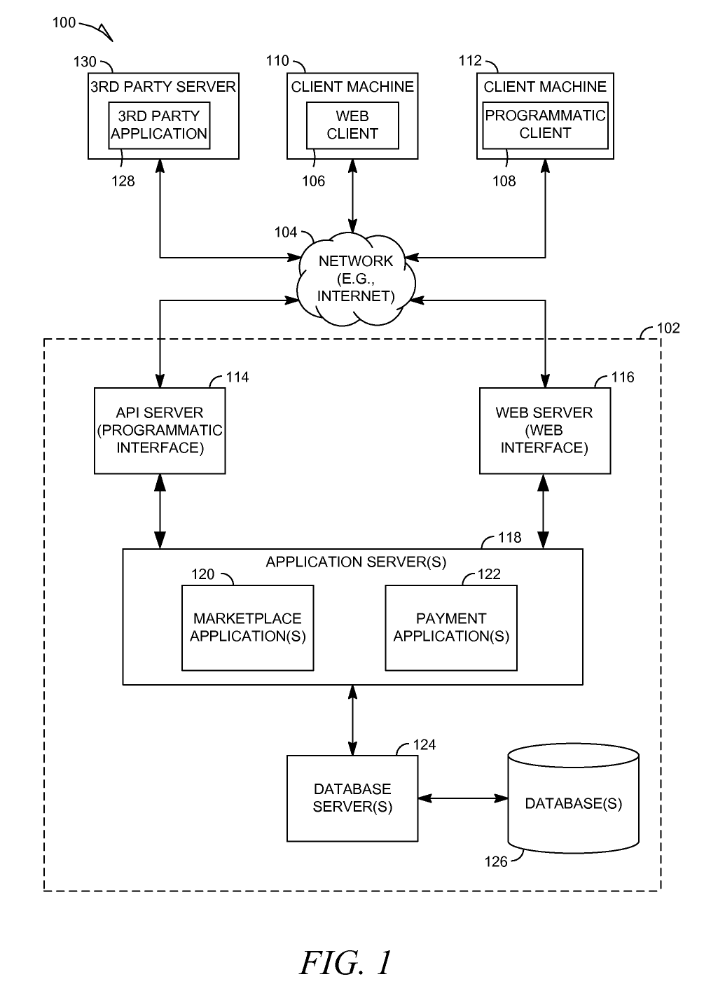

FIG. 1 is a network diagram depicting a client-server system 100, within which one example embodiment may be deployed. A networked system 102, in the example form of a network-based marketplace or publication system, provides server-side functionality, via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to each form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

The client machine 110 or 112 may present information to a user. For example, the client machine 110 may be running a web browser presenting a web page. The user may be a retailer, and the web page may present the retailer with options to enable resellers to resell items, to configure a reseller's markup on an item, to configure a payment plan for a reseller, to configure resellers' relationships with each other, to monitor the resale rate of an item, and so forth. The user may be a reseller, and the web page may present the reseller with options to select items to resell, to configure a markup on an item, to configure a payment plan from a retailer, to configure the reseller's relationship with other resellers, to monitor the profit on an item, and so forth. Alternatively, the user may be a customer, and the web page may present the customer with options to select items to purchase, to enter one or more reseller codes, and so forth.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, social, or payment functions that are supported by the relevant applications of the networked system 102.

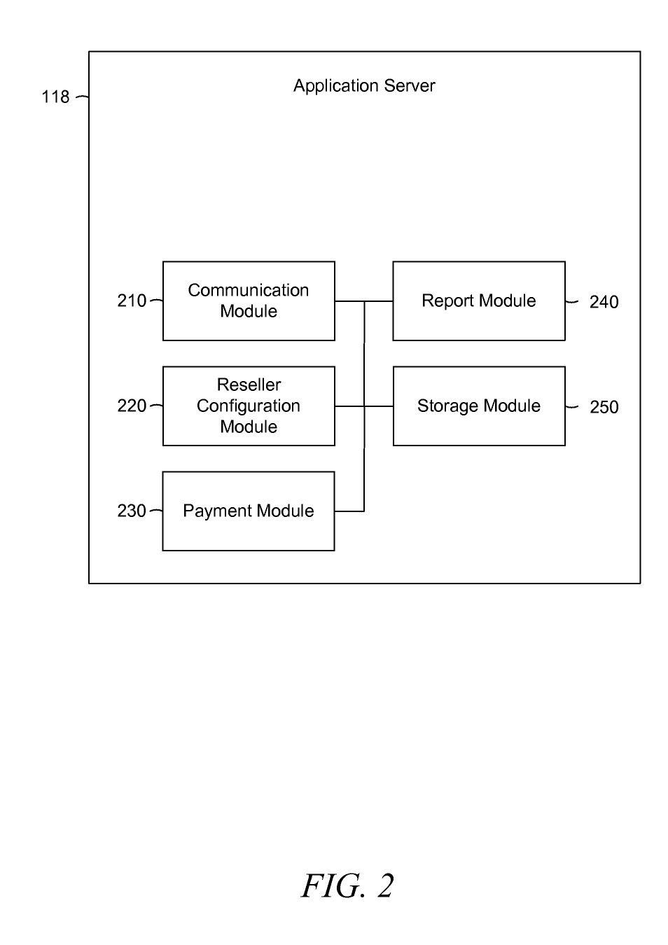

FIG. 2 is a block diagram illustrating components of an application server 118 suitable for multi-level retailing, according to some example embodiments. The application server 118 shown in FIG. 2 may be suitable for communicating with a retailer. The application server 118 is shown as including a communication module 210, a reseller configuration module 220, a payment module 230, a report module 240, and a storage module 250, all configured to communicate with each other (e.g., via a bus, shared memory, a switch, or APIs). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 may control communication with the client machine 110, other application servers 118, and the database 126. The communication module 210 may also send data for storage on the application server 118 or the database 126.

The communication module 210 may receive a retailer login from the client machine 110 or 112. The login credentials of the retailer may be compared to credentials stored in a database to authenticate the retailer.

The reseller configuration module 220 may generate a user interface to allow the retailer to authorize a reseller. For example, the reseller configuration module 220 may generate a hypertext markup language (HTML) document to be sent to the client machine 110 or 112 by the communication module 210. The client machine 110 or 112, running a web browser, may parse the HTML document and present the user interface. The user interface may include controls (e.g., text fields, drop-down menus, checkboxes, radio buttons, etc.) operable to enter information about a reseller. The information about the reseller may include name, address, bank account number, and so on. The user interface may include controls operable to indicate that a reseller has been approved. An approved reseller may be assigned a reseller code. The reseller code may be generated by the reseller configuration module 220 (e.g., be a sequential or pseudo-random number), be provided by the retailer or reseller (e.g., via a user interface control), or come from another source (e.g., a government-assigned number associated with the reseller, such as a social security number, taxpayer identification number, driver's license number, and so on).

The communication module 210 may receive information about a retailer and approval of the retailer from the client machine 110 or 112. The storage module 250 may store the information and the approval in the database 126.

The reseller configuration module 220 may generate a user interface to allow the retailer to configure an authorized reseller. The user interface may present information to the retailer about one or more items for sale by the retailer. The information about the items may include name, image, price, description, and so on. The user interface may include controls operable to allow resellers to resell particular items, categories of items, or all items. For example, a control may be presented that is operable to indicate that a particular toy may be resold. A separate control may be presented that is operable to indicate that all toys may be resold. Alternatively, a single control may be presented that is operable to indicate that the particular toy may be resold or that the all items in the category to which the particular toy belongs may be resold. The user interface may include controls operable to allow items to be resold by particular resellers, groups of resellers, or all resellers. Resellers may be identified by a name, a description, or a reseller code.

The user interface generated by the reseller configuration module 220 may also include controls operable to set the reseller price of one or more items. In some example embodiments, the reseller price is set below the retail price of the item. This may allow the reseller to offer a discount to consumers while still selling the item at a profit. For example, the retail price of an item may be $10, the reseller price may be $8, and the price to the consumer may be $9, allowing the consumer to save $1 off of the retail price while the reseller realizes a $1 profit by reselling the item. The reseller price may be set for a particular item for a particular reseller, for a particular item for all resellers, for all items available for resale for a particular reseller, for all items available for resale for all retailers, or any other suitable option. For example, a particular reseller may have a reseller price of 20% below retail for all items, while another reseller may have a reseller price of 10% below retail on some items and 5% below retail on other items.

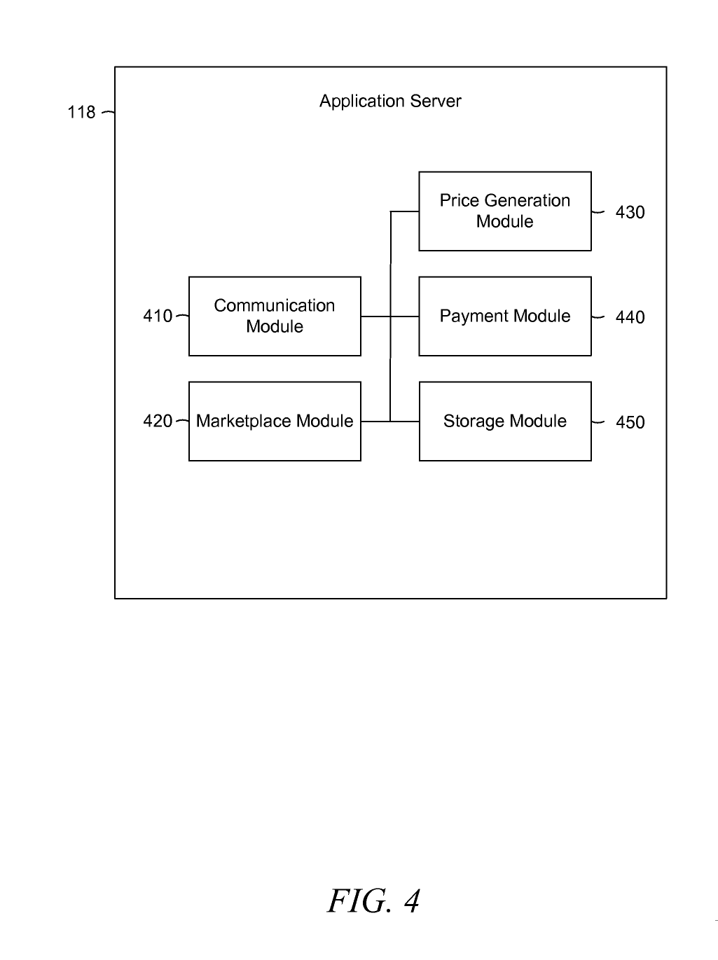

The payment module 230 may generate payments to resellers based on items sold by the retailer for the reseller. For example, a customer may provide a reseller code when purchasing items (as discussed in more detail with respect to FIG. 4) and those items may be associated with the corresponding reseller. The payments may be based on the difference between the price charged to the customer for the item and the reseller price for the item. For example, if the customer price is $9 and the reseller price is $8, a payment of $1 to the reseller may be generated based on the sale of the item to the customer. The payments may be aggregated. For example, a payment may be generated on a monthly basis for the items sold for the reseller that month.

The report module 240 may generate reports for the retailer based on item sales. For example, a report may be generated that shows the total sales associated with each reseller over the past month. As another example, a report may be generated that shows the total sales of each item over the past quarter. A retailer may use the reports to aid in determining which items should be available for resale, the reseller prices for different resalable items, the reseller prices for different resellers, and so forth. The reports may be sent to the client machine 110 or 112 for viewing by the retailer via the communication module 210.

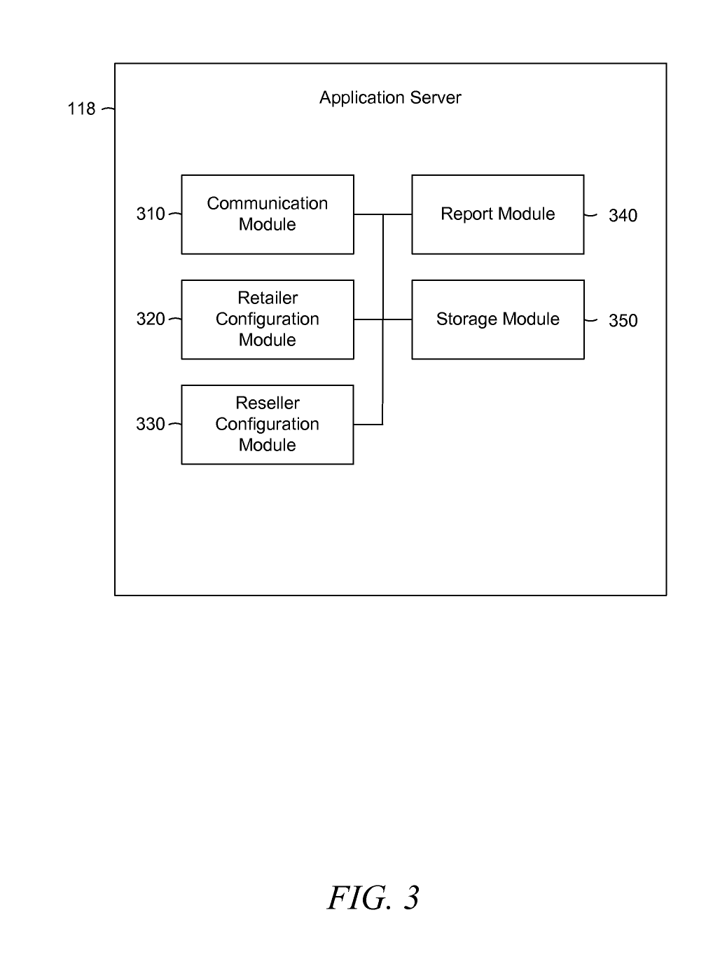

FIG. 3 is a block diagram illustrating components of an application server 118 suitable for multi-level retailing, according to some example embodiments. The application server 118 shown in FIG. 3 may be suitable for communicating with a reseller. In some example embodiments, the modules of FIG. 3 are combined with the modules of FIG. 2 in a single application server 118. The application server 118 is shown as including a communication module 310, a retailer configuration module 320, a reseller configuration module 330, a report module 340, and a storage module 350, all configured to communicate with each other (e.g., via a bus, shared memory, a switch, or APIs). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 310 may control communication with the client machine 110, other application servers 118, and the database 126. The communication module 310 may also send data for storage on the application server 118 or the database 126. The communication module 310 may receive a reseller login from the client machine 110 or 112. The login credentials of the reseller may be compared to credentials stored in a database to authenticate the reseller.

The retailer configuration module 320 may generate a user interface to allow the reseller to configure a relationship with one or more retailers. For example, the reseller configuration module 330 may generate an HTML document to be sent to the client machine 110 or 112 by the communication module 310. The client machine 110 or 112, running a web browser, may parse the HTML document and present the user interface. The user interface may present controls operable to select a retailer to configure, may allow the configuration of multiple retailers at once, or both. The user interface may present information to the reseller about one or more items for sale by the retailer. The information about the items may include name, image, price, description, and so on. The user interface may include controls operable to configure settings for particular items, categories of items, items sold by a particular retailer, or all items.

The user interface generated by the retailer configuration module 320 may also include controls operable to set the customer price of one or more items.

In some example embodiments, the customer price is set above the reseller price of the item and at or below the retail price of the item. Rather than setting the customer price directly, the customer price may be defined as a markup over the reseller price. For example, an item with a reseller price of $8 may have the customer price set at $9 either by directly selecting the $9 customer price or by selecting a $1 markup for the item. A markup may be defined as an absolute amount (e.g., $1) or a percentage (e.g., 12.5%). The markup may be set for a particular item for a particular retailer, for a particular item for all retailers, for all items available for resale for a particular retailer, for all items available for resale for all retailers, or any other suitable option. For example, a reseller may apply a 20% markup for all items for one retailer, while applying individual markups of differing values for items sold by another retailer.

The reseller configuration module 330 may generate a user interface to allow the reseller (the “active reseller”) to configure a relationship with another reseller (the “target reseller”). For example, an authorized reseller may be given the authority by the retailer to authorize other resellers. In this case, the authorizing reseller may be the active reseller and may be presented a user interface similar to that generated by the reseller configuration module 220, discussed above, to authorize a target reseller. Alternatively, a retailer may have authorized both the active reseller and the target reseller. Once authorized, the target reseller may be identified by entering a corresponding reseller code, selecting the reseller's name from a list, or identified in another manner. The target reseller may have a higher or lower position in a reseller hierarchy than the active reseller. For example, the active reseller may have authorized the target reseller and be above the target reseller in the reseller hierarchy. In this case, the active reseller may be presented an option to claim a percentage of the markup charged by the target reseller. As another example, the active reseller may have been recruited by the target reseller and be below the target reseller in the reseller hierarchy. In this case, the active reseller may be presented an option to give a percentage of the active reseller's markup to the target reseller. Other markup-sharing arrangements are possible as well. For example, fixed amounts rather than percentages may be used. In some cases, the fixed amounts are capped at a certain percentage of revenue (e.g., 10%, 100%, or 150%). To illustrate, the active reseller may be entitled to a fixed amount of $500 per month of the target reseller's markup. In this illustration, the active reseller's share is capped at 100% of the target reseller's revenue. Continuing with this illustration, if the target reseller's revenue were $400, the active reseller would claim the entire $400, while if the target reseller's revenue were $5000, the active reseller would claim $500 and the target reseller would claim the other $4500. Should the share to which the active reseller is entitled exceed the target reseller's revenue, the excess may be charged against future revenues or the target reseller requested to pay the difference.

The report module 340 may generate reports for the reseller based on item sales. For example, a report may be generated that shows the total sales associated with each retailer over the past month. As another example, a report may be generated that shows the total sales of each item over the past quarter. A reseller may use the reports to aid in determining which items to advertise, the customer prices for different resellable items, the markup for different retailers, and so forth. The reports may be sent to the client machine 110 or 112 for viewing by the reseller via the communication module 310.

FIG. 4 is a block diagram illustrating components of an application server 118 suitable for multi-level retailing, according to some example embodiments. The application server 118 shown in FIG. 4 may be suitable for communicating with a customer. In some example embodiments, the modules of FIG. 4 are combined with the modules of FIG. 2, the modules of FIG. 3, or both, in a single application server 118. The application server 118 is shown as including a communication module 410, a marketplace module 420, a price generation module 430, a payment module 440, and a storage module 450, all configured to communicate with each other (e.g., via a bus, shared memory, a switch, or APIs). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 410 may control communication with the client machine 110, other application servers 118, and the database 126. The communication module 410 may also send data for storage on the application server 118 or the database 126.

The communication module 410 may receive a customer login from the client machine 110 or 112. The login credentials of the customer may be compared to credentials stored in a database to authenticate the customer.

The marketplace module 420 may generate a user interface to allow a customer to select items for purchase from one or more retailers. For example, the marketplace module 420 may generate an HTML document to be sent to the client machine 110 or 112 by the communication module 310. The client machine 110 or 112, running a web browser, may parse the HTML document and present the user interface. The user interface may present controls operable to select items to purchase and to enter one or more reseller codes. The user interface may present information about one or more items for sale by one or more retailers. The information about the items may include name, image, price, description, and so on. The user interface may include controls operable to allow the user to associate reseller codes with individual items, categories of items, particular retailers, all retailers, and so on.

The customer may select one or more items to purchase. The items may be provided by a single retailer or by multiple retailers. The customer may enter one or more reseller codes. Alternatively, one or more reseller codes may be received in other ways. For example, cookies on the customer's device may indicate one or more reseller codes, parameters provided to the application server 118 may indicate one or more reseller codes (e.g., parameters to an HTML GET or POST request, parameters passed to a programmatic API, etc.), an identifier for the customer may be used to access a database storing reseller codes for the customer, and so forth. The price generation module 430 may generate a price for each item based on the reseller code or codes. For example, if the reseller code or codes are for resellers that are not authorized to resell an item, the price for that item may be the retail price of the item. As another example, if one of the reseller codes is for a reseller that is authorized to resell an item and the other reseller codes are for resellers that are not authorized to resell the item, the authorized reseller's resale price may be used. As yet another example, if multiple reseller codes are for resellers that are authorized to resell an item, the lowest resale price may be used. In some embodiments, the resellers may be prioritized, such that the resale price for the highest priority authorized reseller is used even when the highest priority authorized reseller does not provide the lowest resale price.

The payment module 440 may receive account information from the user via the communication module 410. The payment module 440 may communicate with one or more financial institutions to debit the user's account and credit the retailer's account for the amount of the transaction. The payment module 440 may credit multiple retailer accounts, according to the items sold by each retailer. Each retailer may also be sent the reseller code or codes for the retailer. For example, items from two retailers may be purchased and two reseller codes used (e.g., two reseller codes for two different resellers, or two reseller codes for a single reseller). Each of the reseller codes may apply to only one of the retailers. Accordingly, the one applicable reseller code for each retailer may be sent to that retailer. In another example, multiple retailers may use the same reseller code for a reseller, and the reseller code is sent to each of the multiple retailers.

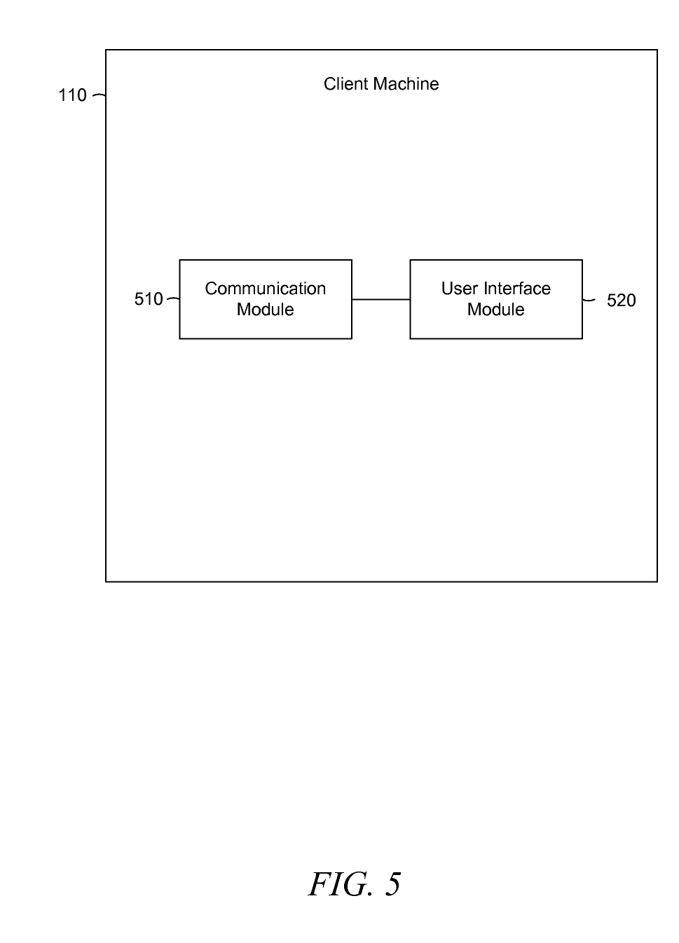

FIG. 5 is a block diagram illustrating components of a client machine suitable for multi-level retailing, according to some example embodiments. The client machine 110 is shown as including a communication module 510 and a user interface module 520, configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 510 may communicate with the application server 118, the network 104, or any suitable combination thereof. Information received via the communication module 510 may be presented (e.g., displayed on a display device or played on an audio device) via the user interface module 520. Items for sale may be selected or reseller codes may be entered by a user using a user interface presented by the user interface module 520. The selected items and reseller codes may be communicated to the application server 118 via the communication module 510.

The user interface module 520 may present information about cost savings for the items. For example, if the retail price of an item is $10 and the user has entered a reseller code for a reseller of the item who has set the customer price of the item to $9, both the retail price and the reseller price may be shown to indicate the price savings received by the user. Alternatively or additionally, the effective $1 discount may be shown. In some example embodiments, the cost savings is not shown.

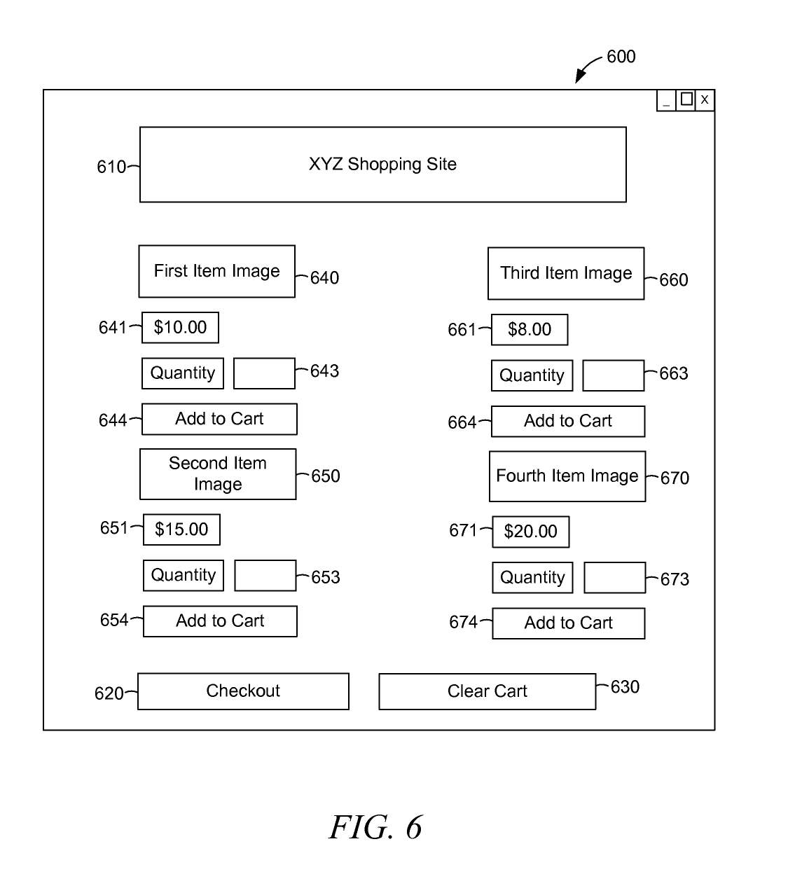

FIG. 6 is a block diagram 600 illustrating a user interface suitable for multi-level retailing, according to some example embodiments. The user interface of block diagram 600 may be suitable for presentation to a customer. As can be seen in block diagram 600, the user interface includes a title 610, information 640-674 about four items, a button 620 labeled “Checkout,” and a button 630 labeled “Clear Cart.” Images 640, 650, 660, and 670 of items may be presented, along with prices 641, 651, 661, and 671 for the items. The items may be provided by one retailer or different items may be provided by different retailers, in any combination. The user may set a quantity in fields 643, 653, 663, and 673 for items to be purchased, and use buttons 644, 654, 664, and 674 to add the corresponding items to a shopping cart. The prices 641, 651, 661, and 671 may be the retail prices for the items or customer prices for the items based on one or more reseller codes. The button 620 may be operable to check out and take the user to a payment screen or otherwise collect payment information. After payment information is collected, the user's account may be debited and the retailers' accounts may be credited. The button 630 may be operable to remove all items from the user's cart.

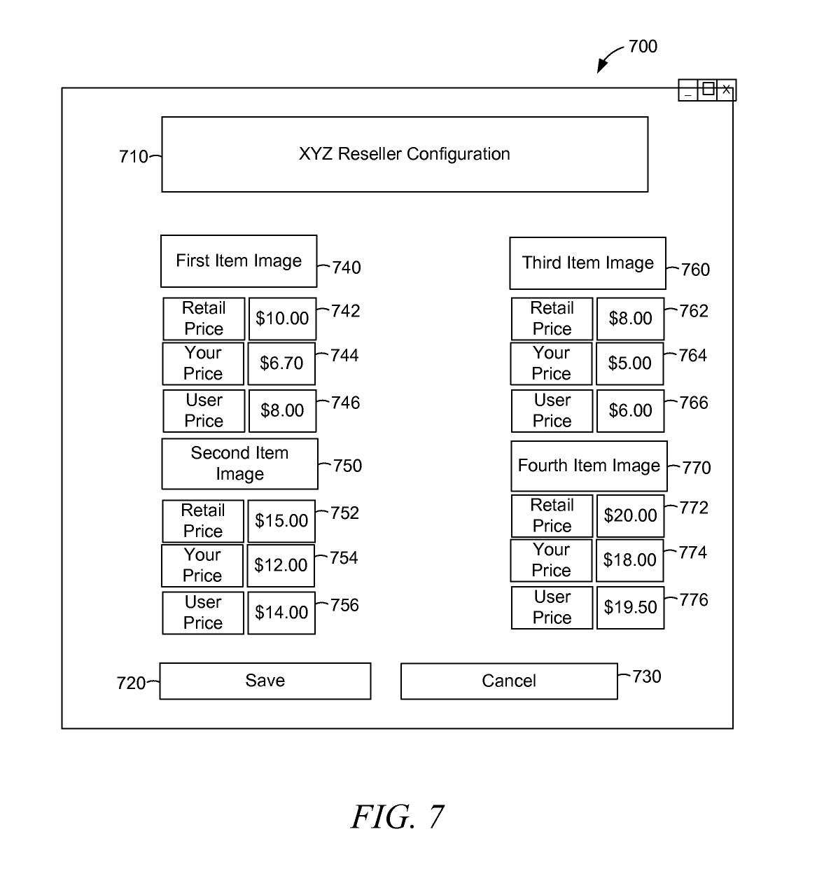

FIG. 7 is a block diagram 700 illustrating a user interface suitable for multi-level retailing, according to some example embodiments. The user interface of block diagram 700 may be suitable for presentation to a reseller. As can be seen in block diagram 700, the user interface includes a title 710, information 740-776 about four items, a button 720 labeled “Save,” and a button 730 labeled “Cancel.” Images 740, 750, 760, and 770 of items may be presented, along with retail prices 742, 752, 762, and 772 and reseller prices 744, 754, 764, and 774 for the items. The retail prices may be the prices charged by the retailer to a consumer for the items. The reseller prices may be the prices charged by the retailer to a reseller of the item. The retail and reseller prices may have been set by the retailer of each item. The reseller may set a user or resale price in fields 746, 756, 766, and 776. The resale price may be a price charged to a consumer for the item when the reseller's reseller code is used. The button 720 may be operable to save the changes to the resale prices made by the reseller. The button 730 may be operable to cancel the changes made by the reseller.

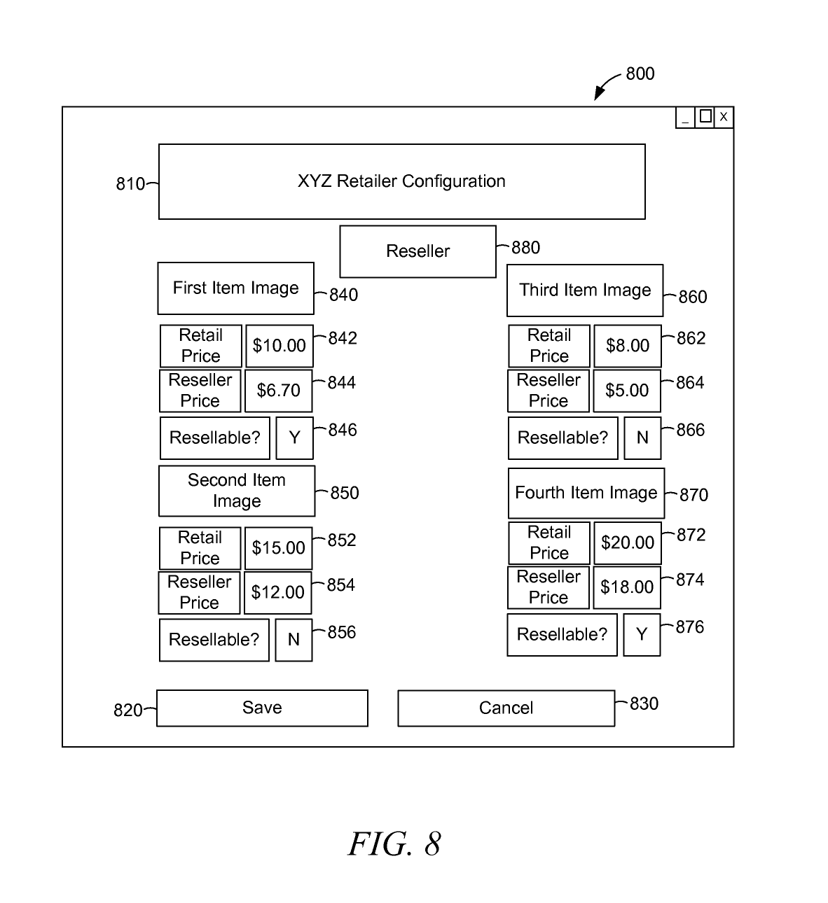

FIG. 8 is a block diagram 800 illustrating a user interface suitable for multi-level retailing, according to some example embodiments. The user interface of block diagram 800 may be suitable for presentation to a retailer. As can be seen in block diagram 800, the user interface includes a title 810, information 840-876 about four items, a reseller field 880, a button 820 labeled “Save,” and a button 830 labeled “Cancel.” Images 840, 850, 860, and 870 of items may be presented, along with retail prices in elements 842, 852, 862, and 872 and reseller prices 844, 854, 864, and 874 for the items.

The retail prices shown in elements 842, 852, 862, and 872 may be the prices charged by the retailer to a consumer for the items. The retailer may be able to modify the retailer price of each item by entering a new price into the corresponding element 842, 852, 862, or 872. The reseller prices may be the prices charged by the retailer to a reseller of the item. The retailer may be able to modify the retailer price of each item by entering a new price into the corresponding element 844, 854, 864, or 874. The retailer may determine if the item is resellable by setting a value in the corresponding element 846, 856, 866, or 876. For example, the value may be Y or N, Yes or No, indicated by color (e.g., green to allow reselling and red to disallow), and the like. The reseller prices and reseller allowability settings may apply to the reseller indicated in field 880 or to any reseller. The indication in field 880 may be a name of the reseller, a description of the reseller, or a reseller code of the reseller. The field 880 may be operable by the retailer to change between resellers. For example, the retailer may be viewing settings for one reseller, then enter a different reseller code into the field 880, causing the user interface to be reloaded with the settings for the reseller corresponding to the entered reseller code. The button 820 may be operable to save the changes to the reseller settings made by the retailer. The button 830 may be operable to cancel the changes made by the retailer.

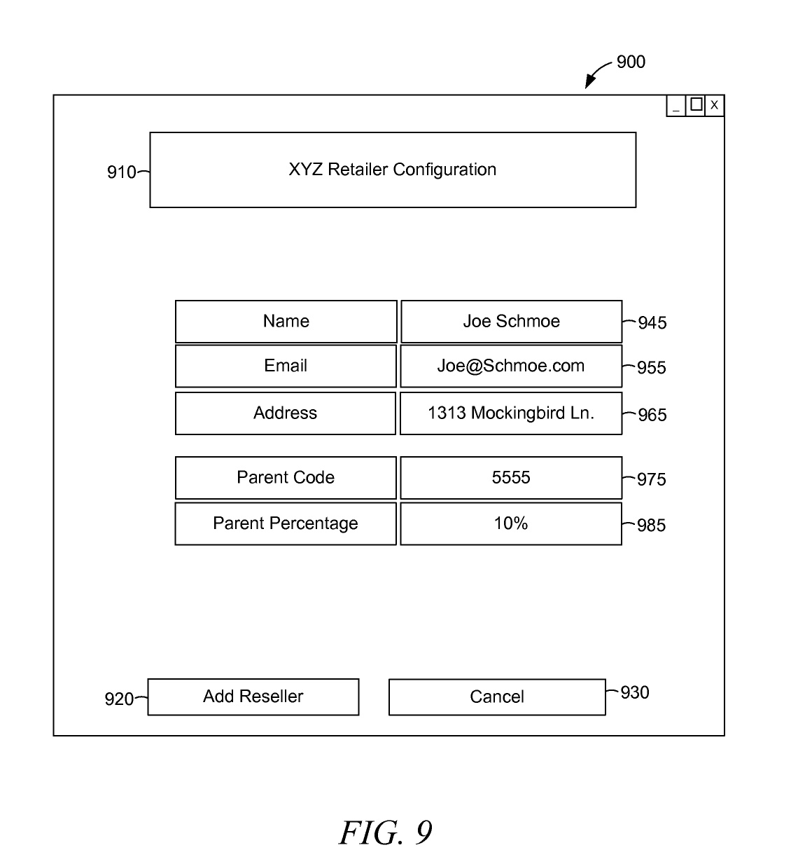

FIG. 9 is a block diagram 900 illustrating a user interface suitable for multi-level retailing, according to some example embodiments. The user interface of block diagram 900 may be suitable for presentation to a retailer and operable to configure reseller options for the retailer. As can be seen in block diagram 900, the user interface includes a title 910, data fields 945, 955, 965, 975, and 985, a button 920 labeled “Add Reseller,” and a button 930 labeled “Cancel.”

The user interface of FIG. 9 may be operable by a retailer to configure an authorized reseller. A name of the reseller may be entered in or displayed in field 945. An email address for the reseller may be entered in or displayed in field 955. A physical address for the reseller may be entered in or displayed in field 965. A reseller code for a parent reseller of the reseller may be entered in or displayed in field 975. A percentage of the reseller's markup may be indicated in the field 985 and assigned to the parent reseller corresponding to the reseller code in field 975. The button 920 may be operable to save the information about the reseller provided in fields 945, 955, 965, 975, and 985. The button 930 may be operable to discard any changes made by the retailer. In some example embodiments, the user interface of FIG. 9 may be operable by a reseller for self-configuration.

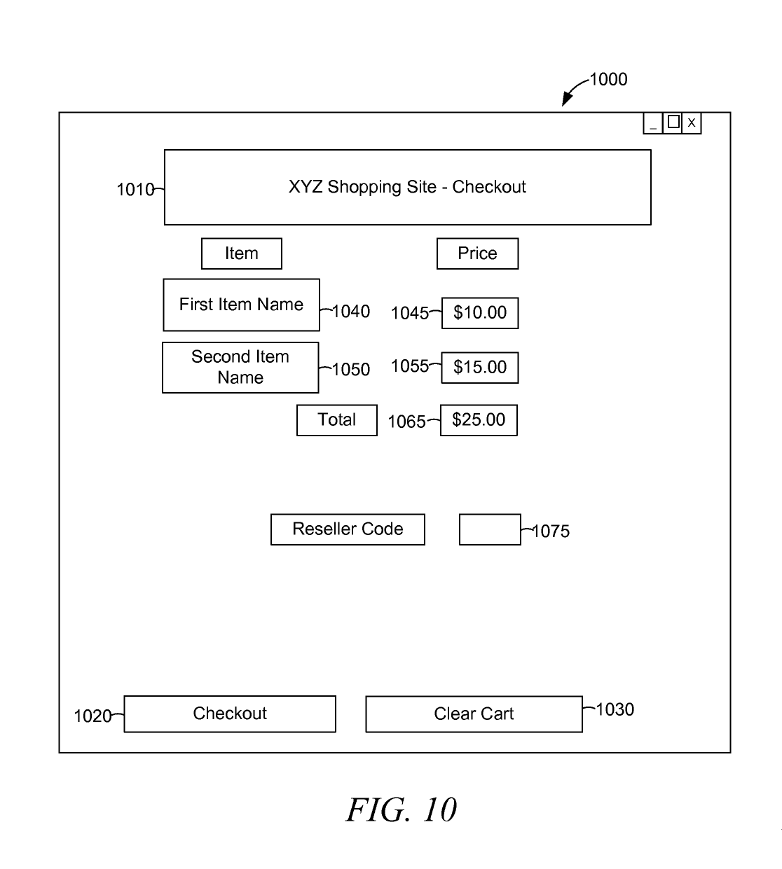

FIG. 10 is a block diagram 1000 illustrating a user interface suitable for multi-level retailing, according to some example embodiments. The user interface of block diagram 1000 may be suitable for presentation to a customer. As can be seen in block diagram 1000, the user interface includes a title 1010, information 1040-1055 about two items, a total cost 1065, a button 1020 labeled “Checkout,” and a button 1030 labeled “Clear Cart.” Names 1040 and 1050 of items may be presented, along with prices 1045 and 1055 for the items. The items may be provided by one retailer or different items may be provided by different retailers, in any combination. The prices 1045 and 1055 may be the retail prices for the items or customer prices for the items based on one or more reseller codes. The field 1075 may be operable by the user to enter a reseller code. A reseller code entered into the field 1075 may be used in addition to or instead of any other reseller codes associated with the user. The reseller code may be used to update the prices presented to the user. For example, the prices 1045 and 1055 may initially be retail prices for the items. Continuing with this example, after the user enters a reseller code into the field 1075, the prices 1045 and 1055 may be updated to show resale prices based on the entered reseller code.

The button 1020 may be operable to check out and take the user to a payment screen or otherwise collect payment information. After payment information is collected, the user's account may be debited and the retailers' accounts may be credited. The button 1030 may be operable to remove all items from the user's cart.

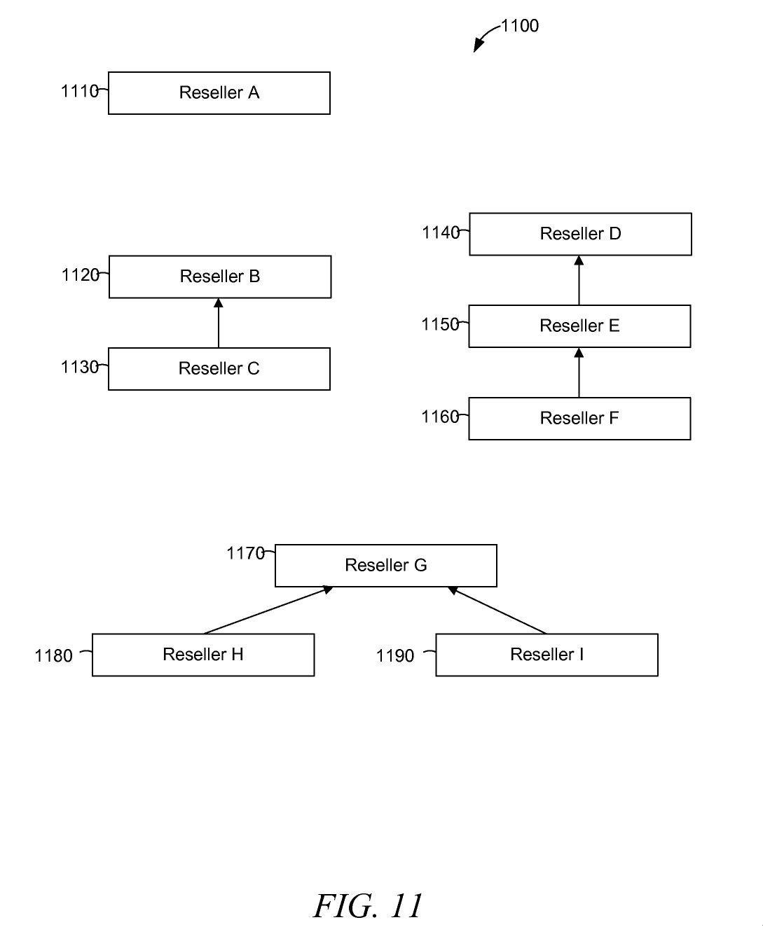

FIG. 11 is a block diagram illustrating a reseller hierarchy 1100 suitable for multi-level retailing, according to some example embodiments. As can be seen in the block diagram of FIG. 10, the reseller hierarchy 1100 includes resellers 1110, 1120, 1130, 1140, 1150, 1160, 1170, 1180, and 1190. The reseller 1110 has neither parent resellers nor child resellers. The reseller 1120 is the parent reseller of the reseller 1130. The reseller 1120 may receive a percentage of the markup for products resold by the reseller 1130.

The reseller 1140 is a parent reseller of the reseller 1150. In turn, the reseller 1150 is a parent reseller of the reseller 1160. The reseller 1140 may receive a percentage of the markup for products resold by the resellers 1150 and 1160. The percentage received by the reseller 1140 may be different for each of the resellers 1150 and 1160 (e.g., may be smaller or larger for the reseller 1160 than for the reseller 1150) or the same for both of the resellers 1150 and 1160. The reseller 1160 may receive a percentage of the markup for products sold by the reseller 1160. The percentage of the reseller 1160 sales received by the reseller 1150 may be the same as the percentage of the reseller 1150 sales received by the reseller 1140.

The reseller 1170 is a parent reseller of the resellers 1180 and 1190. The reseller 1170 may receive a percentage of the markup for products resold by the resellers 1180 and 1190. The percentage received by the reseller 1170 may be different for each of the resellers 1180 and 1190 (e.g., may be smaller or larger for the reseller 1180 than for the reseller 1190) or the same for both of the resellers 1180 and 1190.

The example relationships shown in FIG. 11 may be combined into more complex structures. For example, a reseller may have several child resellers, each of whom may have several child resellers of their own. The distribution of the markup for products sold by each reseller may be determined algorithmically based on the ancestor resellers (e.g., a parent reseller, a grandparent reseller, and so on) of the reseller, or configured individually for each reseller. For example, for one retailer, each parent reseller may receive 5% of the markup of direct child resellers' markup while every other ancestor reseller receives 1% of the reseller's markup. In another example, the percentages may be negotiated on a case-by-case basis between resellers.

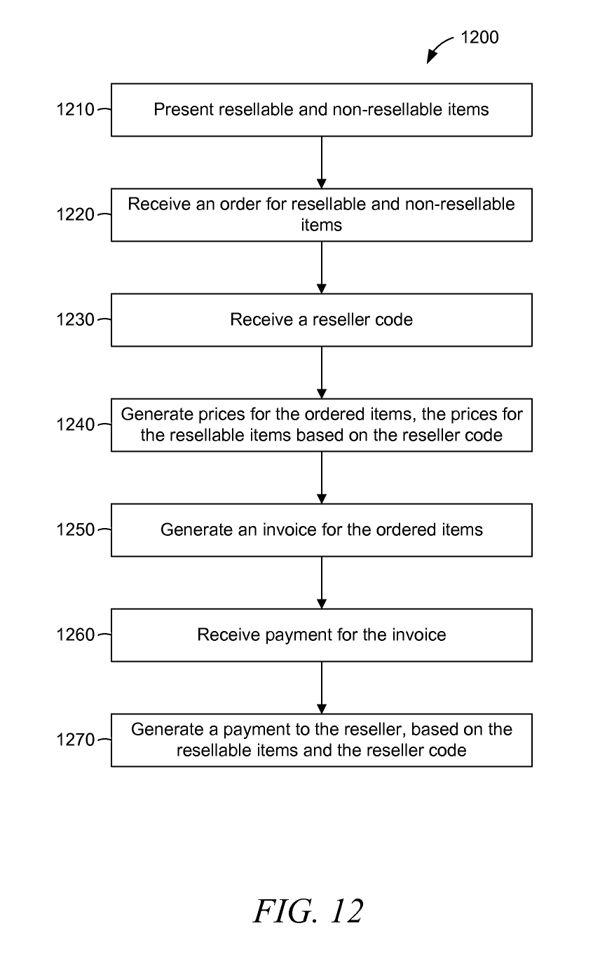

FIG. 12 is a flowchart illustrating operations of an application server 118 in performing methods of multi-level retailing, according to some example embodiments. Operations in the method 1200 may be performed by the application server 118, using modules described above with respect to FIG. 4. As shown in FIG. 12, the method 1200 includes operations 1210, 1220, 1230, 1240, 1250, 1260, and 1270.

An online marketplace may present one or more resellable or non-resellable items to a user (operation 1210). For example, a user interface such as that shown in FIG. 6 may be presented to the user. The presentation of each item may include an indication as to whether the item is resellable or non-resellable. If one or more reseller codes have already been received, the resale price of the item may be presented along with or instead of the retail price.

The user may select one or more of the items for purchase and submit the order to the online marketplace, which receives the order (operation 1220). For example, the button 620 labeled “Checkout” may be operable to submit the order.

A reseller code may be received (operation 1230). For example, the reseller code may be entered by the user into a text field using a user interface such as that shown in FIG. 10, selected by the user from a drop-down list, read from a cookie or other file on the user's device, or received in another way. The reseller code may be received as part of the checkout process or received prior to the presentation of items. In some example embodiments, items are presented with retail prices, then a reseller code is received, and the presentation is refreshed to include resale prices.

The price for each ordered item may be generated based on the item's status as a resellable item and the reseller code (operation 1240). For example, the price of a non-resellable item may be the retail price of the item, while the price of a resellable item may be the reseller price of the item for the reseller corresponding to the reseller code plus a markup for the item for the reseller.

An invoice may be generated for the ordered items (operation 1250). The invoice may include a total amount owed by the user, which may be the sum of the prices for the ordered items. Payment may be received (operation 1260) for the amount invoiced. For example, a debit or credit account of the user may be charged the invoiced amount and an account of the retailer or online marketplace credited. The account information of the user may be entered via a user interface, read with a card reader, accessed from a database, or determined in some other way.

A payment to the reseller corresponding to the reseller code may be generated (operation 1270). For example, a payment in the amount of the total of the reseller's markup on the resellable items may be generated. The reseller's markup may be found by searching a database using the reseller code. The payment may be generated based on a single transaction with a customer, or based on multiple aggregated transactions.

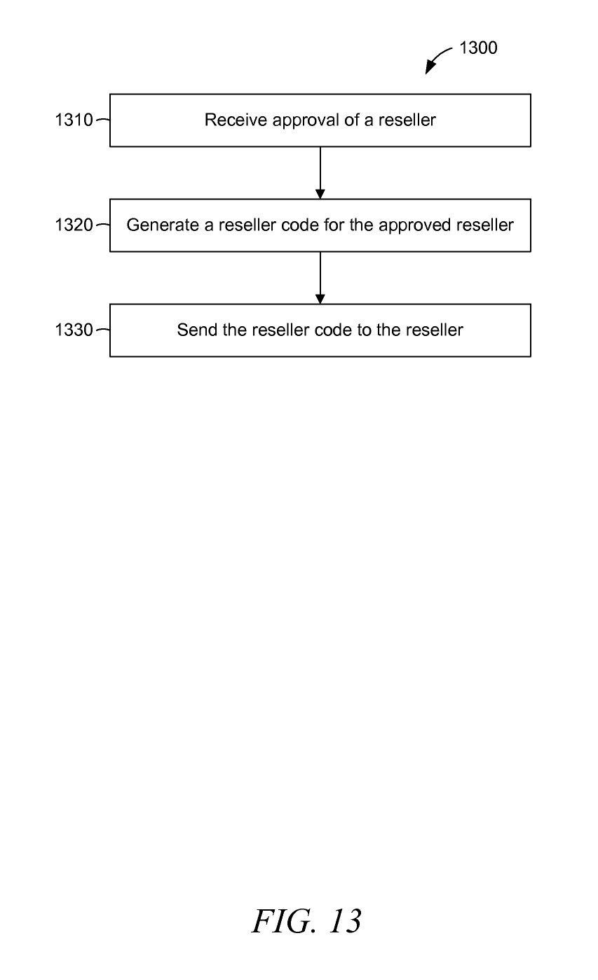

FIG. 13 is a flowchart illustrating operations of an application server 118 in performing methods of multi-level retailing, according to some example embodiments. Operations in the method 1300 may be performed by the application server 118, using modules described above with respect to FIG. 2. As shown in FIG. 13, the method 1300 includes operations 1310, 1320, and 1330.

The application server 118 may receive approval of a reseller (operation 1310). For example, a retailer may approve a reseller using the user interface shown in FIG. 9. The application server 118 may generate a reseller code for the reseller (operation 1320). For example the reseller code may be a sequential number (e.g., reseller 1, 2, 3, etc.), a hash of the reseller data (e.g., an MD5 hash, a SHA-2 hash, or another hash), a public key of the reseller, an existing code for the reseller (e.g., a Social Security number, a Taxpayer Identification number, a driver's license number, etc.), or another code value. The reseller code may be sent to the reseller (operation 1330). For example, the reseller code may be sent in an email, a text message, printed and sent by postal mail, or sent in another way.

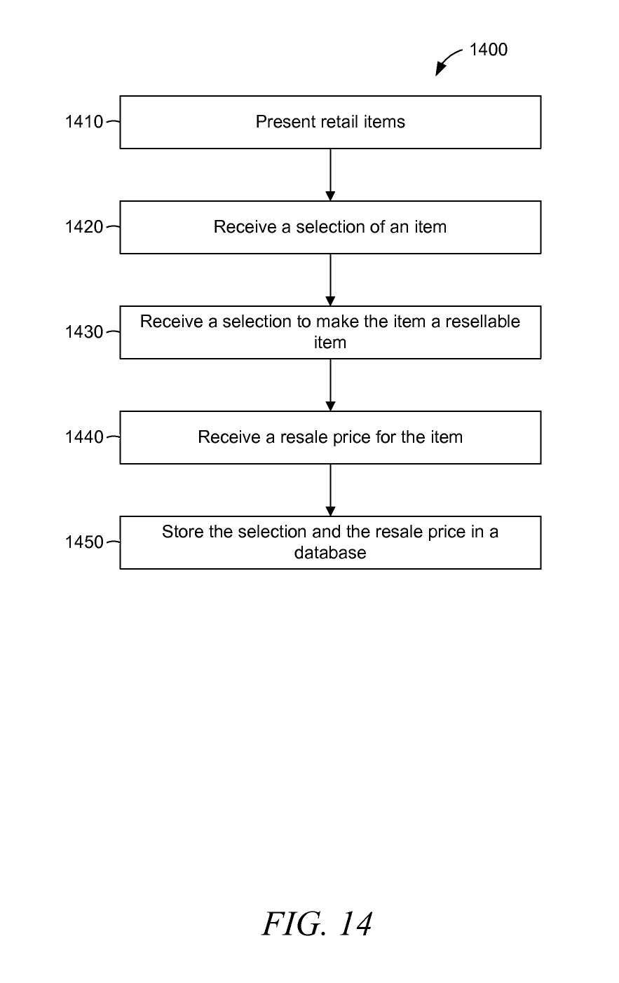

FIG. 14 is a flowchart illustrating operations of an application server 118 in performing methods of multi-level retailing, according to some example embodiments. Operations in the method 1400 may be performed by the application server 118, using modules described above with respect to FIG. 2. As shown in FIG. 14, the method 1400 includes operations 1410, 1420, 1430, 1440, and 1450.

The application server 118 may cause retail items to be presented to a retailer (operation 1410). For example, the application server 118 may be a web server transmitting data via a hypertext transport protocol (HTTP) connection to a web browser of the retailer, causing a user interface such as that shown in FIG. 8 to be presented. The data may include, for each item, an image, a description, a retail price, and the like.

The application server 118 may receive a selection of an item (operation 1420). For example, an image for each item may have been shown to the retailer, an item image may have been selected by a retailer (e.g., by clicking on the image with a mouse, touching the image on a touch screen, etc.), and an identifier of the selected item transmitted to the application server 118. Additional configuration information for the item may also be received. For example, a selection to make the item resellable (operation 1430) may be received. As another example, a reseller price for the item (operation 1440) may be received. The reseller price may be an introductory price associated with a duration. A second reseller price may be received. The introductory price may apply before the duration expires, and the second reseller price may apply after the duration expires. The status of the item as resellable and the reseller price for the item may be stored in a database (operation 1450) for later access.

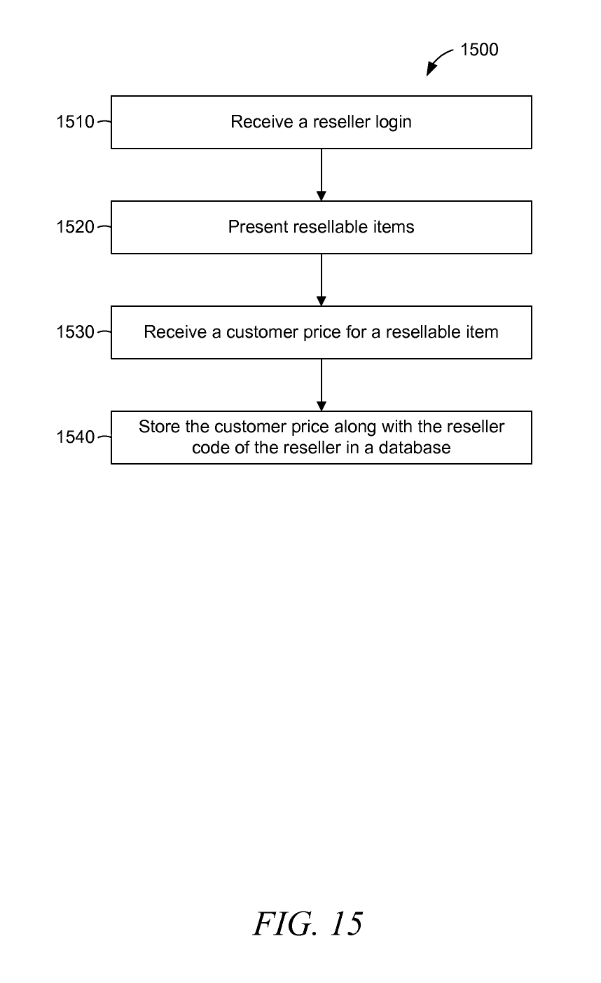

FIG. 15 is a flowchart illustrating operations of an application server 118 in performing methods of multi-level retailing, according to some example embodiments. Operations in the method 1500 may be performed by the application server 118, using modules described above with respect to FIG. 3. As shown in FIG. 15, the method 1500 includes operations 1510, 1520, 1530, and 1540.

The application server 118 may receive a reseller login (operation 1510). For example, a reseller may provide a username and password to login. The application server 118 may present or cause to be presented one or more resellable items (operation 1520) to the reseller. For example, data about items stored in a database in operation 1450 of the method 1400 may be retrieved and sent to the device of the reseller for presentation on a display of the reseller's device. The items may be shown in a user interface like that shown in FIG. 7.

The application server 118 may receive a customer price for a resellable item (operation 1530). For example, the reseller may enter a customer price for an item into a graphical user interface (GUI) such as that shown in FIG. 7. The customer price may be transmitted from the reseller's device to the application server 118. The customer price for the item and the reseller code may be stored in a database (operation 1540). For example, a table may contain records, and each record may include a field identifying an item, a field identifying a reseller, and a field identifying the customer price for the item when resold by the reseller. In various example embodiments, more or fewer fields are used. For example, an additional field identifying the retailer may be present.

According to various example embodiments, one or more of the methodologies described herein may facilitate multi-level retailing. According to various example embodiments, one or more of the methodologies described herein may facilitate the creation of customized multi-level retailing relationships. For example, rather than having a single pricing scheme for resellers and customers, the margins may be determined on an item-by-item, reseller-by-reseller, or other basis. In various example embodiments, one or more of the methodologies described herein may facilitate the creation of customized pricing or advertising campaigns by resellers, who may be able to more dynamically respond to changing market conditions than retailers. For example, rather than frequently updating the price to customers, a retailer may establish an appropriate reseller price and allow the reseller to update the resale price as needed. According to various example embodiments, one or more of the methodologies described herein may facilitate the adjustment of prices for different customers in response to the identification of a reseller code. Computing resources used by one or more machines, databases, or devices (e.g., within the network environment 100) may similarly be reduced. Examples of such computing resources include processor cycles, network traffic, memory usage, data storage capacity, power consumption, and cooling capacity.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

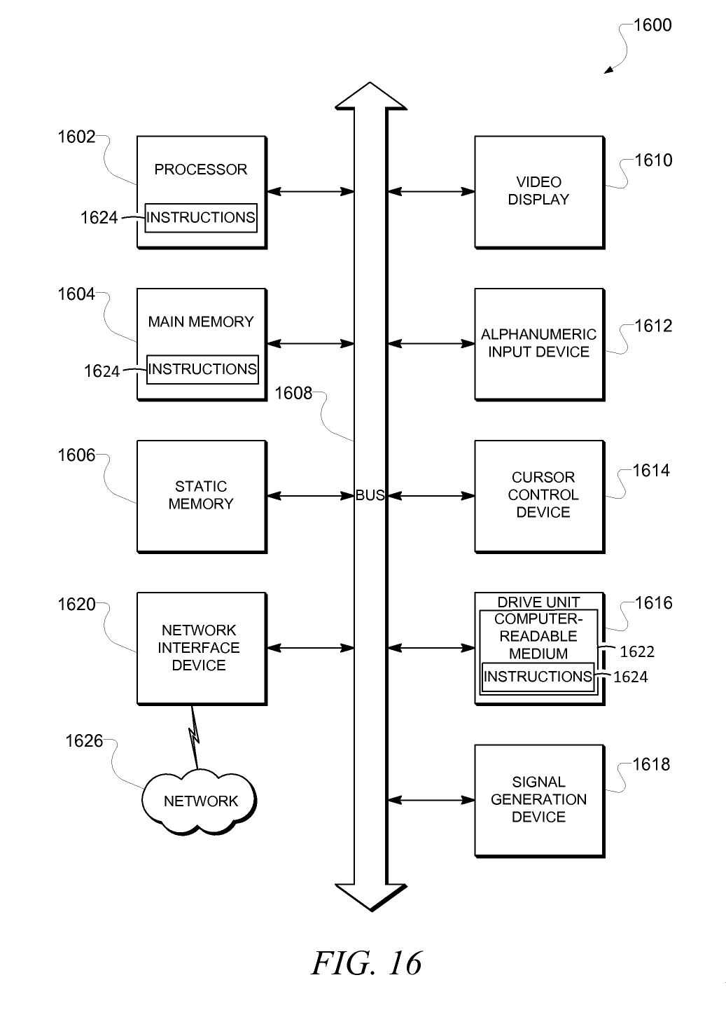

FIG. 16 is a block diagram of machine in the example form of a computer system 1600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a tablet, a wearable device (e.g., a smart watch or smart glasses), a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor 1602 (e.g., a central processing unit (CPU), a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard or a touch-sensitive display screen), a user interface (UI) navigation device 1614 (e.g., a mouse), a disk drive unit 1616, a signal generation device 1618 (e.g., a speaker), and a network interface device 1620.

### Machine-Readable Medium

The disk drive unit 1616 includes a machine-readable medium 1622 on which is stored one or more sets of instructions and data structures (e.g., software) 1624 embodying or utilized by any one or more of the methodologies or functions described herein. The instructions 1624 may also reside, completely or at least partially, within the main memory 1604 and/or within the processor 1602 during execution thereof by the computer system 1600, the main memory 1604 and the processor 1602 also constituting machine-readable media.

While the machine-readable medium 1622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1624 may further be transmitted or received over a communications network 1626 using a transmission medium. The instructions 1624 may be transmitted using the network interface device 1620 and any one of a number of well-known transfer protocols (e.g., HTTP). Examples of communication networks include a local area network (LAN), a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a processor of a machine;
a communication module configured to:
cause a first item for sale to be presented, a first reseller being authorized by a retailer to resell the first item,
cause a second item for sale to be presented, the first reseller not being authorized to resell the second item, and
receive an order for the first item and the second item along with a reseller code identifying the first reseller;
a price generation module configured to:
generate a price for the first item based on the reseller code,
generate a price for the second item that does not depend on the reseller code; and
a payment module coupled to the processor and configured to:
receive a first payment in an amount including the price for the first item and the price for the second item, and
generate a second payment to the first reseller based on the price for the first item, the second payment not based on the price for the second item.

2. The system of claim 1, wherein the first reseller is associated with a second reseller, and the payment module is further configured to generate a payment to the second reseller based on the price for the first item, wherein the payment to the second reseller is not based on the price for the second item.

3. The system of claim 1, wherein the payment to the first reseller is based on a percentage of the price for the first item.

4. The system of claim 3, wherein the percentage is set by the retailer.

5. The system of claim 3, wherein the percentage is set by the first reseller.

6. The system of claim 2, wherein the payment to the second reseller is based on a percentage of the payment to the first reseller.

7. The system of claim 1, wherein the payment to the first reseller is based on a reseller price for the first item that is set by the retailer.

8. The system of claim 1, wherein the payment module is further configured to:
determine that a duration for an initial reseller price has not expired; and wherein
the payment to the first reseller is based on the initial reseller price.

9. The system of claim 1, wherein the payment module is further configured to:
determine that a duration for an initial reseller price has expired; and wherein
the payment to the first reseller is based on a reseller price other than the initial reseller price.

10. A method comprising:
causing information regarding a plurality of items for sale by a retailer to be presented to the retailer, using a processor of a machine;
receiving, from the retailer, a selection of an item of the plurality of items;
receiving, from the retailer, a selection of an option to allow resellers to resell the selected item;
receiving, from the retailer, an indication of a reseller price for the selected item;
storing, in a database, the option to allow resellers to resell the selected item and the reseller price for the item; and
causing to be presented to a reseller, information regarding the selected item, a reseller code identifying the reseller, a retailer price for the selected item, and the reseller price for the selected item, the reseller having been pre-approved by the retailer.

11. The method of claim 10, further comprising:
receiving a profit-sharing percentage for second-tier resellers; and
receiving, from the reseller, a reseller code for a second-tier reseller for the reseller.

12. The method of claim 11, further comprising:
receiving a profit-sharing percentage for third-tier resellers for the reseller; and
receiving, from the second-tier reseller, a reseller code for a third-tier reseller for the second-tier reseller.

13. The method of claim 10, wherein the reseller price for the item is lower than the retailer price for the item.

14. The method of claim 10, wherein the information regarding the plurality of items includes an image of each of the plurality of items.

15. The method of claim 10, further comprising:
receiving, from the retailer, an initial reseller price for the selected item;
receiving, from the retailer, a duration for the initial reseller price; and
storing, in the database, the initial reseller price for the selected item and the duration for the initial reseller price.

16. The method of claim 10, wherein the selection of the item is a selection of a category including the item.

17. A non-transitory machine-readable storage medium comprising instructions that, when executed by one or more processors of a machine, cause the machine to perform operations comprising:
receiving a login from a reseller;
causing to be presented to the reseller, a list of a plurality of items for sale, each item sold by a corresponding retailer, each item having a retailer price and a reseller price;
receiving, from a reseller, a selection of an item of the list of the plurality of items;
receiving, from the reseller, a markup for the selected item; and
sending, to the retailer corresponding to the selected item, the selection, the markup, and a reseller code identifying the reseller.

18. The non-transitory machine-readable storage medium of claim 17, wherein the selection of the item is a selection of a category including the item.

19. The non-transitory machine-readable storage medium of claim 17, the operations further comprising:
receiving, from the reseller, a profit-sharing percentage for second-tier resellers for the reseller; and
receiving, from the reseller, a reseller code for a second-tier reseller for the reseller.

20. The non-transitory machine-readable storage medium of claim 19, the operations further comprising:
receiving, from the reseller, a profit-sharing percentage for third-tier resellers for the reseller; and
receiving, from the second-tier reseller, a reseller code for a third-tier reseller for the second-tier reseller.
